(19) United States
(12) Patent Application Publication
(10) Pub. No.: US 2009/0221240 A1
(43) Pub. Date: Sep. 3, 2009

(54) LOW POWER DEVICE ACTIVATED BY AN EXTERNAL NEAR-FIELD READER

(75) Inventor: Yu ZHANG, Beijing (CN)

Correspondence Address: Locke Lord Bissell & Liddell LLP;Attn: IP Docketing, Three World Financial Center, New York, NY, 10281-2101, US

(73) Assignee: Nokia Corporation, Espoo (FI)

(21) Appl. No.: 12/040,176

(22) Filed: Feb. 29, 2008

(51) Int. Cl. H04B 1/00

(52) U.S. Cl. 455/68; 455/574

(57) ABSTRACT

Method, apparatus, and computer program product embodiments improve power saving in mobile devices. A mobile device includes a controller with a central processing unit and a programmed memory. In its unused state, the controller maintains a sleep mode with the central processing unit off and peripherals off, such as for a flat screen display. The mobile device also includes a passive near-field transponder with an EEPROM storage device. The near-field transponder is activated by a continuous radio frequency signal from a proximate near-field reader. The near-field transponder can receive data from the near-field reader, which the transponder can write into the EEPROM. The mobile device also includes an activation coil energized by the continuous radio frequency signal from the proximate near-field reader and signals the controller when so energized. When the activation coil is energized by the continuous radio frequency signal from the proximate near-field reader, it energizes the controller, turning it on. The controller then reads the received data from the transponder's EEPROM and checks the validity of the received data to be sure that it is not the result of a spurious signal received by the near-field transponder. If the received data is determined to be valid, then the energized controller energizes the peripherals and the CPU and transfers the received data to the CPU. When the activation coil is no longer energized by a proximate near-field reader, the controller then returns to the sleep mode with the central processing unit off. In this manner, power saving in mobile devices is improved.

### FIELD

The embodiments disclosed relate to improvements in power saving in mobile devices.

### BACKGROUND

Near-field transponders, such as radio frequency identification (RFID) transponders and Near-Field Communication (NFC) transponders, include an integrated circuit microchip with data storage capability and a radio frequency (RF) interface, which couples an antenna to the electronic circuit.

RFID transponders can be the passive type or the active type. A passive RFID transponder requires no internal power source to communicate with an RFID reader, and is only active when it is near an RFID reader, which energizes the transponder with a continuous radio frequency signal at a resonant frequency of the antenna. The small electrical current induced in the antenna by the continuous radio frequency signal provides enough power for the integrated circuit in the transponder to power up and transmit a modulated response, typically by backscattering the continuous carrier wave from the RFID reader. A passive RFID transponder can include writable electrically erasable, programmable, read-only memory (EEPROM) for storing data received from the RFID reader, which modulates the continuous carrier wave sent by the RFID reader. Reading distances for passive RFID transponders typically range from a few centimeters to a few meters, depending on the radio frequency and antenna design. By contrast, active RFID transponders require a power source to receive and transmit information with an RFID reader.

NFC transponders communicate with NFC readers via magnetic field induction, where two loop antennas are located within each other's near field, effectively forming an air-core transformer. An example NFC transponder operates within the unlicensed radio frequency ISM band of 13.56 MHz, with a bandwidth of approximately 2 MHz over a typical distance of a few centimeters.

Mobile devices exist in a variety of forms such as personal digital assistants (PDAs), portable audio/video players, wireless cellular telephones, smartcards, or the like and are used for a variety of applications, such as data storage, entertainment, communications, e-commerce, banking, personal identification, mobile ticketing, or similar applications. Mobile devices include a central processing unit (CPU) and a memory and may include a touch screen keyboard and a flat screen display. Mobile devices are self-contained and can include a battery to power the CPU for carrying out the application programs stored in the memory. A mobile device can be combined with a passive near-field transponder, which can receive a coded message from proximate near-field readers to enable the mobile device to perform a programmed function based on the coded message.

A significant problem with mobile devices is that their frequent use imposes a significant drain on their battery. What is needed is an improved way to save power in mobile devices.

### SUMMARY

Method, apparatus, and computer program product embodiments are disclosed to improve power saving in mobile devices. A mobile device includes a controller with a central processing unit (CPU) and a programmed memory. In one embodiment, the mobile device includes a battery to power the CPU in a run mode. In its unused state, the controller maintains a sleep mode with the CPU off and peripherals off, such as for a flat screen display, thereby drawing substantially less or even no power from the battery. The mobile device also includes a passive near-field transponder with an electrically erasable, programmable, read-only memory (EEPROM) storage device. The near-field transponder can be, for example, a radio frequency identification (RFID) transponder, a Near-Field Communication (NFC) transponder, or any other near-field communications device. The near-field transponder is activated by a continuous radio frequency signal from a proximate near-field reader. The passive near-field transponder backscatters a response modulated with the existing data in the EEPROM. The near-field transponder can receive data from the near-field reader, which the transponder can write into the EEPROM.

The mobile device also includes an activation coil energized by the continuous radio frequency signal from the proximate near-field reader and signals the controller when so energized. The controller then transitions to an idle mode and turns on the peripherals, drawing some of the battery's power. The controller then reads the received data from the transponder's EEPROM and the controller checks the validity of the received data to be sure that it is not the result of a spurious signal received by the near-field transponder. If the received data is determined to be valid, the controller then transitions to a run mode and turns on the CPU, drawing the normal operating power of the battery. The CPU then reads the received data either from the controller or from the transponder's EEPROM, which can be a branch address to a selected program stored in the memory of the mobile device. Since the received data is determined to be valid, the branch address is used by the CPU to select the desired program and the CPU executes the selected program. When the CPU completes the execution of selected program, it signals the completion to the controller. In another embodiment, the received data from the transponder's EEPROM can generate an alarm or can enable the controller to activate a special communication medium. If the activation coil is no longer energized by a proximate near-field reader, the controller then returns to the sleep mode with the CPU off and peripherals off, thereby drawing substantially less or even no power from the battery. In this manner, power saving in mobile devices is improved.

In another embodiment, the controller, peripherals, and CPU are not powered by a battery, but instead are powered by the activation coil, which is energized by inductive coupling with the continuous radio frequency signal from the proximate near-field reader. When the activation coil is energized by the continuous radio frequency signal from the proximate near-field reader, it energizes the controller, turning it on. The controller then reads the received data from the transponder's EEPROM and checks the validity of the received data to be sure that it is not the result of a spurious signal received by the near-field transponder. If the received data is determined to be valid, then the energized controller energizes the peripherals and the CPU and causes received data to be transferred the CPU. The CPU operates on the data, such as by branching to a stored program, sounding an alarm, activating a communication channel, or other functions. If the activation coil is no longer energized by a proximate near-field reader, the controller, the peripheral devices, and the CPU are no longer energized and the controller returns to the sleep mode with the CPU off and peripherals off. In this manner, power saving in mobile devices is improved.

### DESCRIPTION OF THE FIGURES

FIG. 1 illustrates an external view and a functional block diagram of an example embodiment of the mobile device 100.

FIG. 2 is a flow diagram of the operation of the mobile device of FIG. 1, using the activation coil to activate the controller from its quiescent sleep mode when in the vicinity of an RFID reader.

FIG. 3 is a circuit diagram of an example activation coil 11 and activation coil circuit 12.

### DISCUSSION OF EXAMPLE EMBODIMENTS

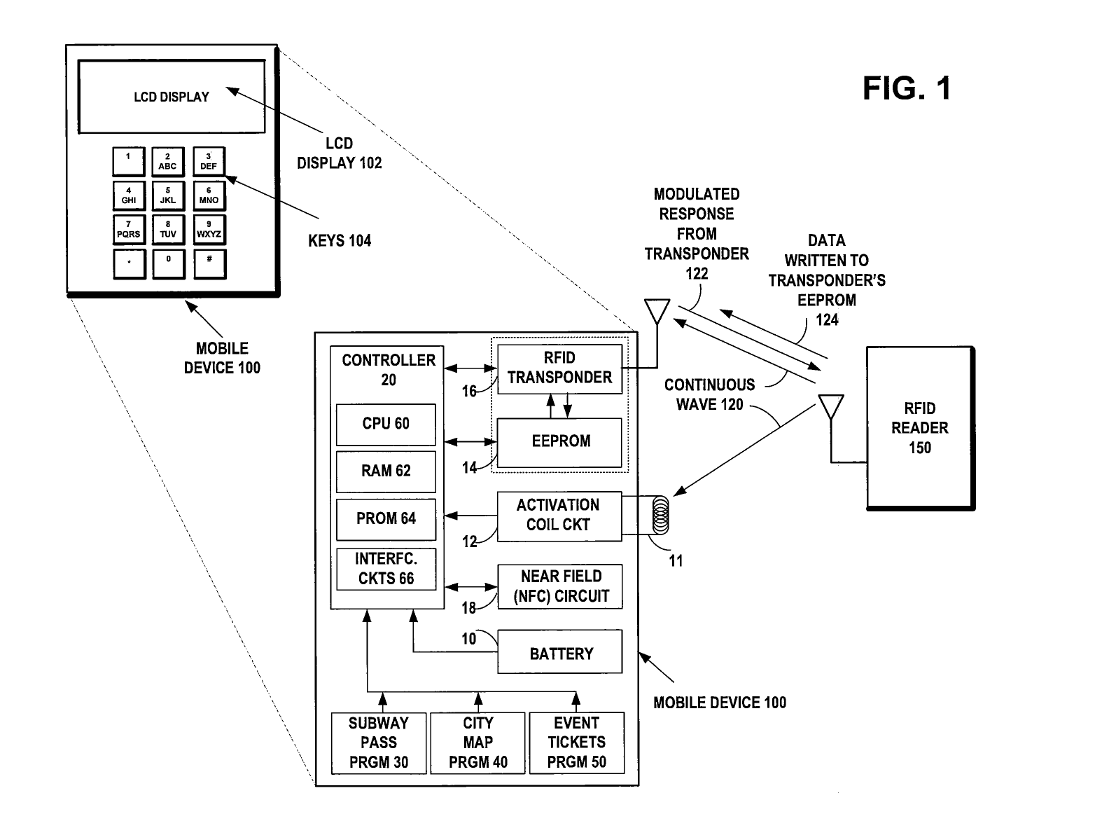

FIG. 1 illustrates an external view and a functional block diagram of an example embodiment of the mobile device 100. The mobile device 100 includes a controller 20 with a central processing unit (CPU) 60, a programmable random-access memory (RAM) volatile memory 62, a programmable read only memory (PROM) 64, interface circuits 66, and a battery 10 to power the CPU 60 in a run mode. The interface circuits 66 are connected to and control the user interface, which can include various types of audio devices, such as microphones, speakers, or earphones, various types of still digital cameras or video digital cameras, various types of visual displays, such as the flat screen display 102, and various types of input devices, such as a trackball, mouse, stylus, button keys, or the touch screen keys 104. In its unused state, the controller 20 maintains a sleep mode with the CPU 60 off and peripherals 102 and 104 off, thereby drawing substantially less or even no power from the battery 10.

The mobile device 100 also includes a passive radio frequency identification (RFID) transponder 16 with an electrically erasable, programmable, read-only memory (EEPROM) 14 storage device. The passive RFID transponder 16 is activated by a continuous radio frequency signal 120 from a proximate RFID reader 150, at the resonant frequency of the transponder's antenna. The passive RFID transponder 16 backscatters a response signal 122 modulated with the existing data in the EEPROM 14. The RFID transponder 16 can receive data from the RFID reader 150, in the form of a modulation of the continuous wave from the reader, which the transponder 16 can write into the EEPROM 14.

The mobile device 100 also includes an activation coil 11, which is energized by inductive coupling with the continuous radio frequency signal 120 from the proximate RFID reader 150 and the activation coil circuit 12 signals the controller 20 when so energized. The controller 20 then transitions to an idle mode and turns on the peripherals 102 and/or 104, drawing some of the battery's power 10. The controller 20 then reads the received data from the transponder's EEPROM 14 and the controller checks the validity of the received data to be sure that it is not the result of a spurious signal received by the transponder 16. The spurious signal, for example, could be from a mobile phone or an invalid RFID reader. If the received data is determined to be valid, the controller 20 then transitions to a run mode and turns on the CPU 60, drawing the normal operating power of the battery 10.

The CPU 60 then reads the received data either from the controller 20 or from the transponder's EEPROM 14, which can be a branch address to a selected program 30, 40, or 50 stored in the memory 62 of the mobile device 100 and the CPU executes the selected program. The programs 30, 40, and 50 can provide various services for the user associated with the geographic location of the particular RFID reader 150 that energizes the RFID transponder 16.

In another embodiment, the received data from the transponder's EEPROM can enable the controller to generate an alarm or can enable the controller to activate a special communication medium, such as the Near-Field Communication (NFC) circuit 18 to enable contactless communication with an NFC reader device.

For example, program 30 can be a Subway Pass program, which enables the mobile device 100 to maintain a current stored-value used for payment for trips within a subway system of a city. In its unused state, the controller 20 maintains a sleep mode with the CPU 60 off and peripherals 102 and 104 off, thereby drawing substantially less or even no power from the battery 10. At the start of a subway trip from a subway station in the city, when the user approaches an entrance turnstile having an RFID reader 150, the passive RFID transponder 16 receives from the RFID reader 150 a branch address value for the Subway Pass program 30, which the RFID transponder 16 writes into the EEPROM 14. The passive RFID transponder 16 also receives from the RFID reader 150 a location value identifying the location of the RFID reader 150 and its turnstile in the subway system, which the RFID transponder 16 writes into the EEPROM 14.

The activation coil 11 is energized by the continuous radio frequency signal 120 from the proximate RFID reader 150. The controller 20 is thus energized by the activation coil 11, transitions to an idle mode and turns on the peripherals, drawing some of the battery's power. The controller 20 then reads the received data from the transponder's EEPROM 14 and the controller 20 checks the validity of the received data to be sure that it is not the result of a spurious signal received by the transponder 16. If the received data is determined to be valid, the controller 20 then transitions to a run mode and turns on the CPU 60, drawing the normal operating power of the battery. The CPU 60 then reads the received data either from the controller 20 or from the transponder's EEPROM 14. The CPU 60 then accesses the branch address value that the RFID reader has sent to the EEPROM 14 of the RFID transponder 16 and uses the branch address to access the Subway Pass program 30 and load it into the RAM 62 for execution by the CPU. The program 30 then instructs the CPU 60 to write into the PROM 64 the location value of the entrance turnstile and RFID reader 150 in the subway system, as a starting location for the trip.

As the user walks through the turnstile and leaves the vicinity of the entrance RFID reader 150, activation coil 11 is no longer energized by the continuous radio frequency signal 120. In response, the controller 20 returns to the sleep mode with the CPU 60 and the peripherals 102 and 104 off, thereby drawing substantially less or even no power from the battery 10. The user then rides the subway to the intended destination station.

When the user reaches the destination station and approaches an exit turnstile having an RFID reader 150, the passive RFID transponder 16 receives from the exit RFID reader 150 a branch address value for the subway Pass program 30, which the RFID transponder 16 writes into the EEPROM 14. The passive RFID transponder 16 also receives from the exit RFID reader 150 a location value identifying the location of the exit RFID reader 150 and its turnstile in the subway system, which the RFID transponder 16 writes into the EEPROM 14.

The activation coil 11 is energized by the continuous radio frequency signal 120 from the exit RFID reader 150. The controller 20 is thus energized by the activation coil 11, transitions to an idle mode and turns on the peripherals, drawing some of the battery's power. The controller 20 then reads the received data from the transponder's EEPROM 14 and the controller 20 checks the validity of the received data to be sure that it is not the result of a spurious signal received by the transponder 16. If the received data is determined to be valid, the controller 20 then transitions to a run mode and turns on the CPU 60, drawing the normal operating power of the battery. The CPU then reads the received data either from the controller 20 or from the transponder's EEPROM 14. The CPU 60 then accesses the branch address value that the RFID reader has sent to the EEPROM 14 of the RFID transponder 16 and uses the branch address to access the Subway Pass program 30 and load it into the RAM 62 for execution by the CPU. The program 30 instructs the CPU 60 to access the PROM 64 to determine whether this is the beginning or the end of a subway trip. Since the PROM 64 stores the location value of the entrance turnstile as a starting location for the trip, program 30 instructs the CPU 60 to write the starting location value into the EEPROM 14 of the RFID transponder 16 and to signal the RFID transponder 16 to transmit the starting location value to the exit RFID reader 150 in a modulated response, by backscattering the continuous carrier wave from the RFID reader. The exit RFID reader 150 then computes the charge for the subway trip as a function of the difference between the starting location and the destination location of the exit RFID reader 150. The passive RFID transponder 16 then receives from the exit RFID reader 150 the amount charged for the trip, which the CPU 60 accesses from the EEPROM 14 of the RFID transponder 16, deducts from the current stored-value in the PROM 64, and stores the balance in the PROM 64. The CPU 60 can output the balance value to the LCD display 102 for presentation to the user.

As the user walks through the exit turnstile and leaves the vicinity of the exit RFID reader 150, activation coil 11 is no longer energized by the continuous radio frequency signal 120. In response, the controller 20 returns to the sleep mode with the CPU 60 and the peripherals 102 and 104 off, thereby drawing substantially less or even no power from the battery 10.

Other example programs stored in the mobile device 100 can include a city map program 40 and an event tickets program 50. When the CPU 60 completes the execution of selected program 30, 40, or 50, it signals the completion to controller 20. If the activation coil 11 is no longer energized by a proximate RFID reader, the controller 20 then returns to the sleep mode with the CPU 60 off and peripherals 102 and 104 off, thereby drawing substantially less or even no power from the battery 10. In this manner, power saving in mobile devices is improved.

The mobile device 100 of FIG. 1 can also include a Near-Field Communication (NFC) circuit 18 to enable contactless communication with a reader device, such as would be associated with the turnstiles in the above subway pass example. The NFC circuit 18 can exchange data with a reader device, such as the amount charged for the subway trip. NFC communicates via magnetic field induction, where two loop antennas are located within each other's near field, effectively forming an air-core transformer. It operates within the unlicensed radio frequency ISM band of 13.56 MHz, with a bandwidth of approximately 2 MHz over a typical distance of a few centimeters.

In another embodiment, the transponder 16 can be a Near-Field Communication (NFC) transponder to enable contactless communication with the reader device 150, which can be an NFC reader device. In this embodiment, the activation coil 11 is energized by inductive coupling via the near field of the loop antenna of the reader 150.

In another embodiment, the CPU 60 is not powered by a battery, but instead is powered by the activation coil 11, which is energized by inductive coupling with the continuous radio frequency signal 120 from the proximate near-field reader 150. When the activation coil 11 is energized by the continuous radio frequency signal 120 from the proximate near-field reader 150, it energizes the controller 20, turning it on. The controller 20 then reads the received data from the transponder's EEPROM 14 and checks the validity of the received data to be sure that it is not the result of a spurious signal received by the transponder 16. If the received data is determined to be valid, then the energized controller 20 energizes the peripherals and the CPU 60 and transfers the received data to the CPU 60. The CPU 60 can read the received data either from the controller 20 or from the transponder's EEPROM 14 and operate on the data, such as by branching to a stored program, sounding an alarm, activating a communication channel, or other functions. If the activation coil is no longer energized by a proximate near-field reader 150, the controller 20, the peripheral devices 102 and 104, and the CPU 60 are no longer energized and the controller 20 returns to the sleep mode with the CPU 60 off and peripherals 102 and 104 off. In this manner, power saving in mobile devices is improved.

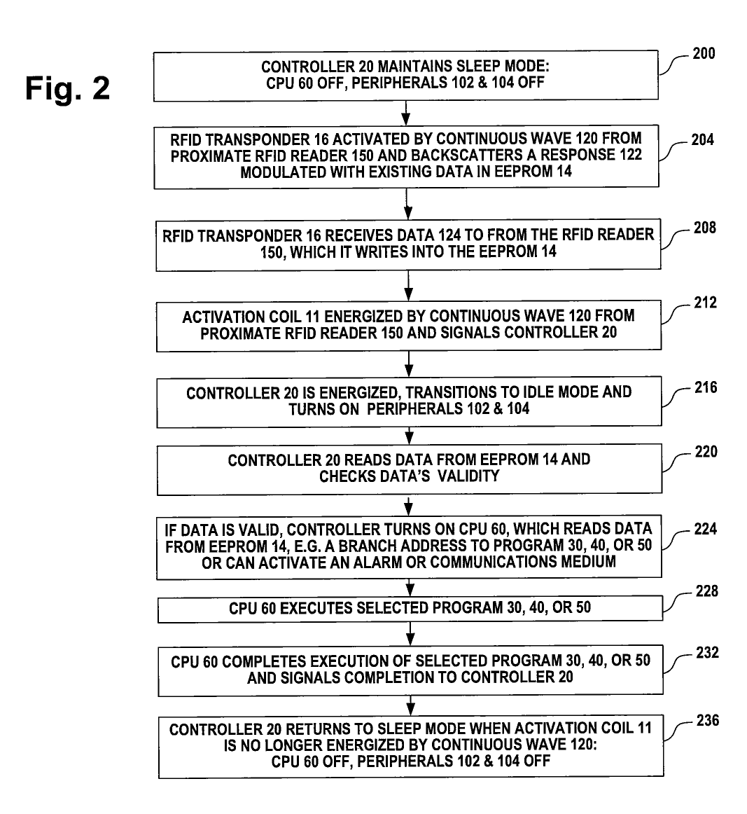

FIG. 2 is a flow diagram of the operation of the mobile device of FIG. 1, using the activation coil to activate the controller from its quiescent sleep mode when moving into the vicinity of an RFID reader. The method of the flow diagram can be embodied as program logic stored in the RAM 62 and/or PROM 64 in the form of sequences of programmed instructions which, when executed in the controller 20 and/or the CPU 60, carry out the functions of the disclosed embodiments.

The method of FIG. 2 includes the following example steps:

Step 200: In its unused state, the controller 20 maintains a sleep mode with the CPU 60 off and peripherals 102 and 104 off, thereby drawing substantially less or even no power from the battery 10.

Step 204: The passive RFID transponder 16 is activated by a continuous radio frequency signal 120 from a proximate RFID reader 150. The passive RFID transponder 16 backscatters a response 122 modulated with the existing data in the EEPROM 14.

Step 208: The RFID transponder 16 receives data from the RFID reader 150, which the transponder 16 can write into the EEPROM 14.

Step 212: The mobile device 100 also includes an activation coil 11 that is energized by the continuous radio frequency signal 120 from the proximate RFID reader 150 and the activation coil 11 signals the controller 20 when so energized.

Step 216: In one example embodiment, the controller 20 then transitions to an idle mode and turns on the peripherals 102 and/or 104, drawing some of the battery's power 10. In another example embodiment, the controller, peripherals, and CPU are not powered by a battery, but instead are powered by the activation coil 11, which is energized by inductive coupling with the continuous radio frequency signal from the proximate RFID reader.

Step 220: The energized controller 20 then reads the received data from the transponder's EEPROM 14, and checks the validity of the received data to be sure that it is not the result of a spurious signal received by the transponder 16.

Step 224: If the received data is determined to be valid, then the energized controller energizes the peripherals and the CPU and transfers the received data to the CPU, which can be a branch address to a selected program 30, 40, or 50 stored in the memory 62 of the mobile device 100.

Step 228: The CPU 60 then executes the selected program 30, 40, or 50.

Step 232: When the CPU 60 completes the execution of selected program 30, 40, or 50, it signals the completion to controller 20.

Step 236: If the activation coil is no longer energized by a proximate RFID reader, the controller 20 then returns to the sleep mode with the CPU 60 off and peripherals 102 and 104 off. Where the CPU is powered by a battery, power is no longer drawn from the battery 10.

In this manner, power saving in mobile devices is improved.

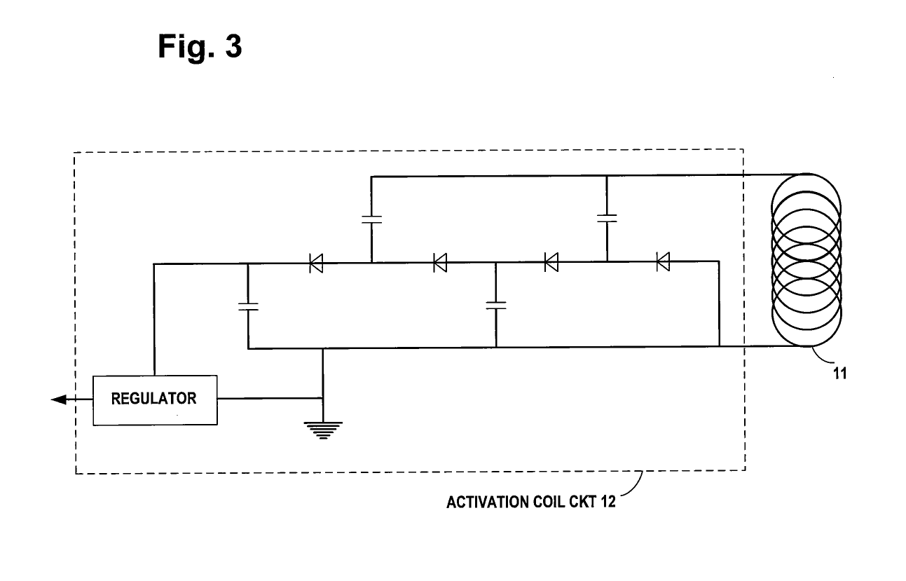

FIG. 3 is a circuit diagram of an example activation coil 11 and activation coil circuit 12. The activation coil 11 will have an induced voltage when exposed to the continuous radio frequency signal 120 from a nearby RFID reader 150. The diodes in the circuit rectify the pulses of induced voltage from the inductance of the coil 11 and the parallel capacitors build a positive DC voltage that is applied to the regulator. The output of the regulator is the enabling signal applied to the controller 20 to initiate its transition from the sleep mode to the idle mode and the run mode. The regulator limits the magnitude of voltage input to the controller 20 to avoid damaging it. When the mobile device 100 is moved away from an RFID reader 150 so that the activation coil 11 is no longer exposed to the continuous radio frequency signal 120, the DC voltage applied to the regulator quickly dissipates. This causes the controller 20 to transition back to the sleep mode. This transition back to the sleep mode can be delayed for a predetermined interval by means of programming a timer in the controller 20.

The controller 20 can be, for example, a PIC18F8527 Flash Microcontroller, manufactured by Microchip Technology Inc. The PIC Microcontroller device includes a 16-bit CPU, programmable instruction and data memories, various timers and peripheral interfaces. The transition from the sleep mode to the idle mode and the run mode can be staged to occur after predetermined intervals by means of programming a timer in the controller 20. The PIC Microcontroller device is packaged in an 80-pin, thin quad flat pack (TQFP), which is a type of integrated circuit packaging designed for use in limited space applications such as mobile devices. The PIC Microcontroller device has the power managed modes of:

[1] Run: CPU on, peripherals on;

[2] Idle: CPU off, peripherals on; and

[3] Sleep: CPU off, peripherals off.

The PIC Microcontroller device's idle mode currents can be as low as 15 μA and the sleep mode current can be as low as 0.2 μA. The device is described in PIC18F8722 Family Data Sheet, 64/80-Pin, 1-Mbit, Enhanced Flash Microcontrollers with 10-bit A/D and nanoWatt Technology, published by Microchip Technology Inc., 2004.

### CONCLUSION

The resulting embodiments of the invention improve power saving in mobile devices. Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks.

The transponder 16 can be a radio frequency identification (RFID) transponder, a Near-Field Communication (NFC) transponder, or any other near-field communications device.

Although specific example embodiments have been disclosed, a person skilled in the art will understand that changes can be made to the specific example embodiments without departing from the spirit and scope of the invention.

What is claimed is:

1. An apparatus, comprising:
a controller including a central processing unit and a memory, said controller configured to maintain a sleep mode with the central processing unit off;
a near-field transponder coupled to the controller, configured to be activated by a continuous radio frequency signal from a proximate near-field reader; and
an activation coil coupled to the controller, configured to be energized by the continuous radio frequency signal from the near-field reader and signaling the controller when so energized;
said controller configured to transition to a run mode to turn on the central processing unit in response to said signaling from said activation coil.

2. The apparatus of claim 1, which further comprises:
a battery to power the central processing unit in response to the controller transitioning to the run mode.

3. The apparatus of claim 1, which further comprises:
said central processing unit being powered by the activation coil, configured to be energized by the continuous radio frequency signal from the near-field reader.

4. The apparatus of claim 1, which further comprises:
said near-field transponder being a radio frequency identification transponder.

5. The apparatus of claim 1, which further comprises:
said near-field transponder being a near-field communication transponder.

6. The apparatus of claim 2, which further comprises:
said controller configured to return to the sleep mode with the central processing unit off, thereby drawing substantially less or no power from the battery, if the activation coil is no longer energized by a proximate near-field reader.

7. The apparatus of claim 2, which further comprises:
said controller further configured to transition to an idle mode and turn on peripheral devices drawing some of the battery's power, in response to said signaling from said activation coil.

8. The apparatus of claim 1, which further comprises:
said near-field transponder configured to store data received from the near-field reader; and
said controller configured to read said data from said near-field transponder.

9. The apparatus of claim 8, which further comprises:
said data read from the transponder enabling the controller to generate an alarm.

10. The apparatus of claim 8, which further comprises:
said data read from the transponder enabling the controller to activate a special communication medium.

11. The apparatus of claim 8, which further comprises:
said data read from the transponder being subjected to a validity test by the controller.

12. The apparatus of claim 11, which further comprises:
said controller configured to turn on said central processing unit only if said data read from the transponder is valid.

13. The apparatus of claim 8, which further comprises:
said data read from the transponder being a branch address to a selected program stored in the memory of the controller;
said central processing unit configured to execute the selected program.

14. The apparatus of claim 3, which further comprises:
said controller configured to return to the sleep mode with the central processing unit off, if the activation coil is no longer energized by a proximate near-field reader.

15. A method, comprising:
maintaining a sleep mode with a central processing unit off;
activating a near-field transponder by a continuous radio frequency signal from a proximate near-field reader;
energizing an activation coil by the continuous radio frequency signal from the proximate near-field reader; and
transitioning to a run mode and turning on the central processing unit in response to said energizing.

16. The method of claim 15, which further comprises:
receiving data in the near-field transponder from the near-field reader, and storing the data in the transponder;
validity testing said data; and
reading the data from the transponder.

17. The method of claim 16, which further comprises:
selecting a program with the data read from the transponder; and
executing the selected program with the central processing unit.

18. The method of claim 15, which further comprises:
returning to the sleep mode with the central processing unit off, if the activation coil is no longer energized by a proximate near-field reader.

19. The method of claim 15, which further comprises:
transitioning to an idle mode and turning on peripheral devices in response to said energizing.

20. The method of claim 15, which further comprises:
sending a backscatter response from the near-field transponder to the near-field reader, modulated with existing data.

21. The method of claim 16, which further comprises:
powering said central processing unit with a battery in response to the controller transitioning to the run mode.

22. The method of claim 16, which further comprises:
powering said central processing unit with the activation coil energized by the continuous radio frequency signal from the near-field reader.

23. The method of claim 16, which further comprises:
generating an alarm in response to said data read from the transponder.

24. The method of claim 16, which further comprises:
activating a special communication medium in response to said data read from the transponder.

25. A computer program product, comprising:
a computer readable medium including program instructions executable by a computer;
program instructions in the computer readable medium for maintaining a sleep mode with a central processing unit off; and
program instructions in the computer readable medium for transitioning to a run mode and turning on the central processing unit in response to energizing an activation coil by the continuous radio frequency signal from the proximate near-field reader.

26. The computer program product of claim 25, comprising:
program instructions in the computer readable medium for receiving data in a near-field transponder, received from the near-field reader, and storing the data in the transponder;
program instructions in the computer readable medium for validity testing said data; and
program instructions in the computer readable medium for turning on said central processing unit.

27. The computer program product of claim 26, comprising:
program instructions in the computer readable medium for selecting a program with the data read from the transponder; and
program instructions in the computer readable medium for executing the selected program with the central processing unit.

28. An apparatus, comprising:
means for maintaining a sleep mode with a central processing unit off;
means for activating a near-field transponder by a continuous radio frequency signal from a proximate near-field reader;
means for energizing an activation coil by the continuous radio frequency signal from the proximate near-field reader; and
means for transitioning to a run mode and turning on the central processing unit in response to said energizing.

29. A method, comprising:
maintaining a sleep mode with a central processing unit off; and
transitioning to a run mode and turning on the central processing unit in response to energizing an activation coil by a continuous radio frequency signal from a proximate near-field reader.

30. The method of claim 29, comprising:
receiving data in a near-field transponder, received from the near-field reader, and storing the data in the transponder;
validity testing said data; and
reading the data from the transponder with the central processing unit.

31. The method of claim 30, comprising:
selecting a program with the data read from the transponder; and
executing the selected program with the central processing unit.

32. The method of claim 30, which further comprises:
powering said central processing unit with a battery in response to the controller transitioning to the run mode.

33. The method of claim 30, which further comprises:
powering said central processing unit with the activation coil energized by the continuous radio frequency signal from the near-field reader.

34. The method of claim 30, which further comprises:
generating an alarm in response to said data read from the transponder.

35. The method of claim 30, which further comprises:
activating a special communication medium in response to said data read from the transponder.
